(19) United States
(12) Patent Application Publication
(10) Pub. No.: US 2015/0326315 A1
(43) Pub. Date: Nov. 12, 2015

(54) Bucket Truck Operational Improvement Apparatus

(71) Applicants: Joseph Georgiano, Hicksville, NY (US); Irwin Math, Greenvale, NY (US)

(72) Inventors: Joseph Georgiano, Hicksville, NY (US); Irwin Math, Greenvale, NY (US)

(21) Appl. No.: 14/718,282

(22) Filed: May 21, 2015

Related U.S. Application Data
(63) Continuation of application No. 13/371,115, filed on Feb. 10, 2012.

(51) Int. Cl. H04B 10/25; B66F 11/04

(52) U.S. Cl. CPC H04B 10/25; B66F 11/04

(57) ABSTRACT

An insulated bucket truck intercom facilitates safe/reliable bucket-to-cab and bucket-to-ground communications during truck operations, while in close proximity to high voltage power sources/lines. A truck-powered cab transceiver and battery-powered bucket transceiver are selectively interconnected by fiber optic cable to maintain high voltage electrical isolation of at least 10 KV/foot. A hands-free bucket transceiver liberates bucket workers from depressing a PTT button to communicate during repair operations. A PTT cab transceiver prevents stray sounds from distracting bucket workers. Bucket elevation through extension of the telescoping boom, with fiber optic cable secured thereto, is accommodated by a self-storing fiber optic reel assembly positioned at each section. Play in the cable and a spring-loaded pulley member accommodates boom articulation. A cab transceiver radio interface permits interference-free communication between the bucket transceiver and/or the cab transceiver, with a remote walkie-talkie up to 10 miles distant. A sensor warns of imminent truck tipping from boom overreaching.

### CROSS REFERENCE TO RELATED APPLICATIONS

This application is a continuation of U.S. patent application Ser. No. 13/371,115, having the title, “Fiber Optic Intercom for Bucket Truck Application,” filed on Feb. 10, 2012, the disclosure of which is hereby incorporated by reference.

### FIELD OF THE INVENTION

The present invention relates to improvements in bucket truck operations, and more particularly to a specially adapted intercom system for a bucket truck permitting bucket-to-cab communication during bucket truck operations.

### BACKGROUND OF THE INVENTION

Bucket trucks are utilized in many different operations, such as for tree removal/pruning, window washing, fruit picking, animal rescue, hanging decorations, exterior painting, and fire rescue, but bucket trucks are also heavily utilized for maintenance on overhead electrical utility and telecommunications lines. It is these maintenance operations in particular where, in addition to the safety concerns regarding proper operation of the truck and the boom holding the bucket, that safety with respect to performing the maintenance task at hand is critical. For some repairs, the utility workers may intentionally interrupt the power to more safely conduct the operations, but very often, work is performed, even as to replacing a utility pole, without interrupting the electrical supply.

In either scenario, the steps to be completed by the repair person must be carefully performed with the necessary tools while perched at significant heights above the ground within a small bucket, and as such, they require careful attention to the proper procedures and the step currently being completed. Distractions can be disastrous. Some of these difficult operations are described within the prior art U.S. Pat. No. 7,814,725 to Kwon for “Method for Replacing Concrete Utility Pole Without Interrupting Power Supply by Adopting Pole Clamp and Pole Crusher.” An illustrative drawing figure from Kwon is reproduced herein as FIG. 1, to be representative of certain prior art operations.

There is no disclosure within Kwon regarding communication between the worker high up in the bucket, with either a co-worker on the ground or the crane operator, and there certainly is no provision for communications over longer distance with other utility workers that may be coordinating on certain tasks to accomplish an area-wide repair. While shouting between parties may be an obvious and last resort, it may serve to distract the worker, particularly if he/she must divert his attention to direct his voice, which may be necessary when the bucket of an aerial lift is elevated to a working height of 150 feet above the ground, which is serviceable using, for example, the Altec AH150 truck series, A typical bucket truck with multiple articulating arms and a telescoping boom is shown in FIG. 1A.

While the use of cell phones or radios may seemingly enable communications when working at such heights, their use is not concomitant with safe operations. Moreover, their use, while neither being safe or practical, also may not be possible or be consistently reliable. Such bucket trucks typically work next to high voltage power sources or lines, which interfere with radio communications, and cell phones depend on functional cell towers being within range, which may not be consistently available in remote locations or where power has been interrupted and needs to be restored.

Thus there is a need to facilitate safe and reliable communications between the worker in the bucket of an aerial lift, and his/her co-workers on the ground or at some distance away. This invention accomplishes those goals and overcomes the drawbacks inherent in other means of communication.

### OBJECTS OF THE INVENTION

It is an object of the invention to provide a safe means of communication between a worker in the bucket of an aerial lift vehicle, and co-worker in the cab of the vehicle.

It is another object of the invention to provide a reliable means of communication between a worker in the bucket of an aerial lift vehicle, and co-worker in the cab of the vehicle.

It is a further object of the invention to provide a means of communication between a worker in the bucket of an aerial lift vehicle and a co-worker operating a distance away.

It is another object of the invention to provide a means of communication between a worker in the bucket of an aerial lift vehicle and a co-workers, when performing operations in proximity to high voltage power sources or lines.

It is also an object of the invention to provide a means of hands-free communication for the worker in the bucket of an aerial lift vehicle when elevated at substantial distances above the ground.

Further objects and advantages of the invention will become apparent from the following description and claims, and from the accompanying drawings.

### SUMMARY OF THE INVENTION

A bucket truck intercom system is provided for use on an insulated bucket truck to facilitate bucket-to-cab communication during maintenance operations. The intercom system is specially conceived and adapted to provide a safe and reliable means of communication between a worker in the bucket of an aerial lift vehicle, and a co-worker in the cab of the vehicle or at some distance away, even when the bucket may be in close proximity to high voltage power sources or lines. The system is effective even when operating in locations without cell phone availability.

The bucket truck intercom system may comprise a truck cab communication device, a bucket communication device, and a fiber optic cable selectively interconnecting the two devices. The fiber optic interconnection may serve to maintain high voltage electrical isolation between the bucket and truck cab, while permitting local bucket-to-cab communication that are free from electrical interference,

The truck cab communication device and the bucket communication device may each comprise a transceiver that may include a speaker and microphone. To liberate the bucket worker from the task of depressing a push-to-talk (or push-to-transmit, “PTT”) button while executing electrical repair tasks, the bucket transceiver may be configured for hands-free communication with the truck cab transceiver, once it is powered on. Hands-free operation may occur from the microphone transmitting continuously or instead by being activated through some hands-free trigger, such as by being voice activated by the vocal sounds uttered by the bucket worker. The truck cab transceiver may preferably be a PTT transceiver, to alleviate stray sounds from unnecessarily reaching and potentially distracting or surprising the bucket worker. In addition, upon depressing the FYI′ button, the system may cause a low sounding beep at the bucket transceiver speaker, to alert the bucket worker that a message will be forthcoming, to avoid the utility worker in the cab potentially speaking loudly and shocking the bucket worker, particularly if the volume was left on high for the bucket transceiver.

The fiber optic cable may selectively interconnect the truck cab transceiver with the bucket transceiver by spanning from the bucket to the cab, while being capable of following the variable movements achievable by the articulating arm sections supporting the bucket, as well as the extendable sections of a telescoping boom. To accommodate elevation of the bucket by extension of the boom, a self-storing fiber optic reel assembly may be positioned in proximity to each section of the telescoping boom. A small amount of play in the fiber optic cable, in conjunction with a spring-loaded pulley member, may accommodate small rotational movement resulting from articulation of the joints in the arm supporting the bucket. This arrangement serves to achieve high voltage electrical isolation between the bucket and truck cab of at least 10 KV/foot.

The cab transceiver may preferably be powered by the truck, while the bucket transceiver, to preserve the electrical isolation of the bucket, may preferably be battery powered. The bucket transceiver battery may be an externally accessible rechargeable battery unit. To boost reliability of the system for lengthy work operations, the cab transceiver may also include a battery charging unit and a spare bucket-transceiver battery being rechargeable therein. To be reliable during inclement weather, the bucket transceiver may be housed in a water-proof metal housing, and in addition, the externally accessible rechargeable battery may be waterproof as well.

To leverage the capability of the system for communication with the bucket worker to other workers on the ground, or to other workers in nearby vehicles, the truck cab transceiver may comprise a radio interface facilitating transmissions to a handheld radio, which would be less susceptible to interference than a radio situated near the bucket. The radio interface may thereby permit communication between either of the hands-free bucket transceiver or the cab transceiver with a remote walkie-talkie/transceiver during bucket truck operations. The radio interface preferably accommodates communication with the remote walkie-talkie for distances of up to 10 miles, which would assist crews that may be working on making repairs throughout a town.

As an additional precaution for safely maneuvering the bucket of the truck, a sensor may be positioned on each of the truck's outriggers to warn the boom operator of potential tipping of the truck, due to overreaching by the boom/bucket combination. A microprocessor may compare readings from each of the outrigger arm load sensors to determine if an excessive imbalance exists. An audible alarm in the bucket and/or in the cab, may serve to alert the workers of imminent tipping.

### BRIEF DESCRIPTION OF TILE DRAWINGS AND TABLES

FIG. 1 is a view of a prior art bucket truck repair operation illustrating a worker performing tasks up in the bucket in close proximity to electrical and/or communication lines.

FIG. 1A illustrates a typical bucket truck with multiple articulating arms and a telescoping boom.

FIG. 2A is a cab intercom transceiver unit of the present invention for use on a bucket truck.

FIG. 2B is a bucket intercom transceiver unit of the present invention for use on a bucket truck.

FIG. 2C is a perspective view of the separate battery unit that is usable in conjunction with the bucket transceiver of the present invention.

FIG. 2D is a top view of the battery unit of FIG. 2C, showing the port for receiving a waterproof connector and mounting flanges for engagement by a quick-release mounting clamp of mounting bolts.

FIG. 3 is a block diagram illustrating use of the transceiver of FIG. 2 with a remote Bucket Intercom Transceiver unit in a typical Bucket Truck Application.

FIG. 4 illustrates a bucket truck utilizing the fiber optic intercom system of the present invention to facilitate repair operations, with the bucket worker speaking while working with both hands, and with the cab worker depressing the push-to-talk button to communicate.

FIG. 4A is a spring-loaded pulley-member usable with the current invention.

FIG. 5 is a block diagram illustrating additional features of the Point-to-Point Fiber Optic Intercom of the present invention.

Table 1 comprises technical specifications for one embodiment of the transceivers and fiber optic cable of the present invention.

### DETAILED DESCRIPTION OF THE INVENTION

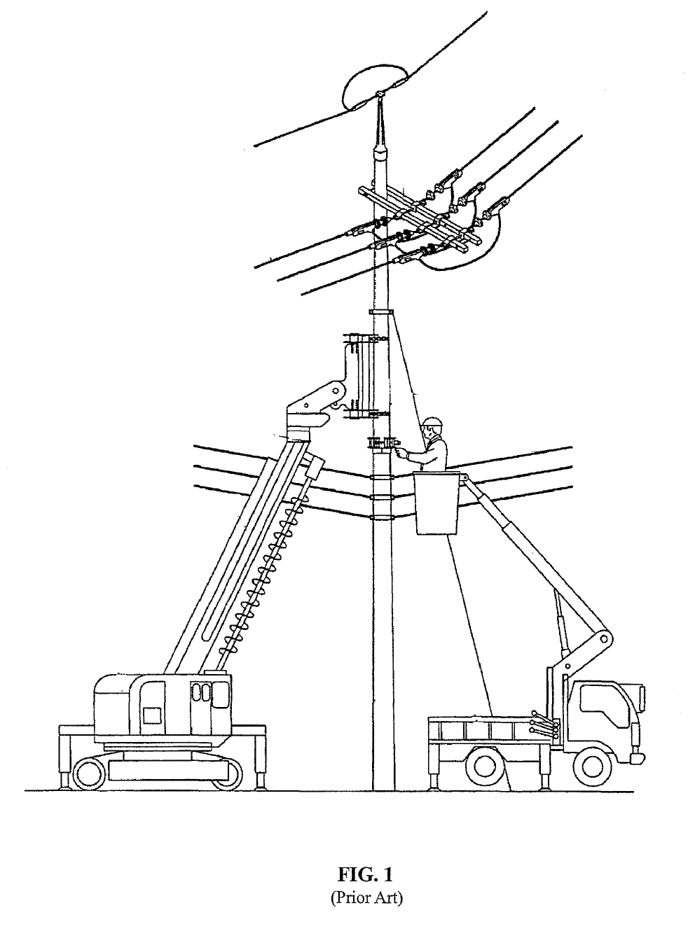

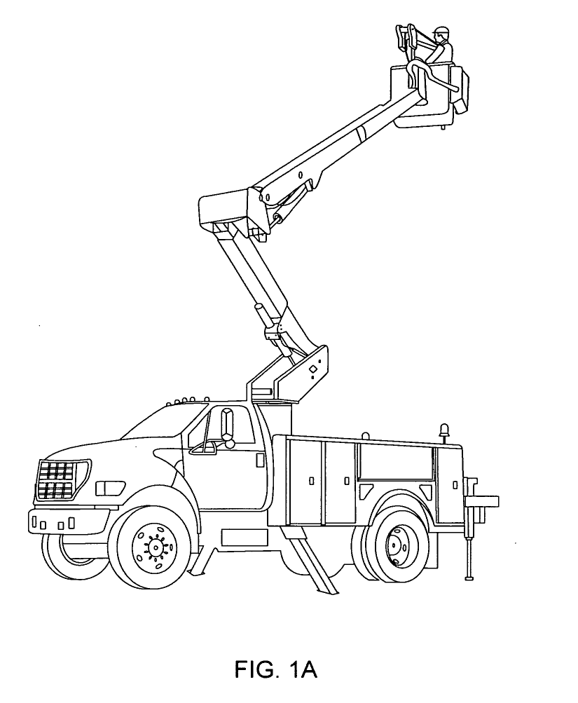

FIG. 1 shows a prior art bucket truck repair operation described within U.S. Pat. No. 7,814,725 to Kwon for “Method for Replacing Concrete Utility Pole without Interrupting Power Supply by Adopting Pole Clamp and Pole Crusher.” In FIG. 1, a worker is conducting repair operations from within a bucket that is elevated to be in close proximity to electrical and/or communication lines. However, no accommodation is provided or discussed within this or other prior art disclosures to facilitate easy communication between the bucket worker and another worker that may be within the truck's cab or a worker located elsewhere on the nearby grounds. The situation is exacerbated when, for certain trucks with articulating arms and a telescoping boom (see e.g., FIG. 1A) the bucket may elevated as high as 150 feet and the worker is performing challenging tasks. Yelling or being yelled at while working at such heights as the primary means of communication constitutes a safety hazard and is counterproductive. Radios may not function in close proximity to high voltage sources and lines due to interference therefrom, while cell phone service may be unavailable in remote areas, or may be unavailable due to a power failure rendering the nearest cell tower inoperative. The intercom system of the present invention easily facilitates the above noted and other useful communications with the bucket worker, while preserving the electrical isolation of the truck's bucket.

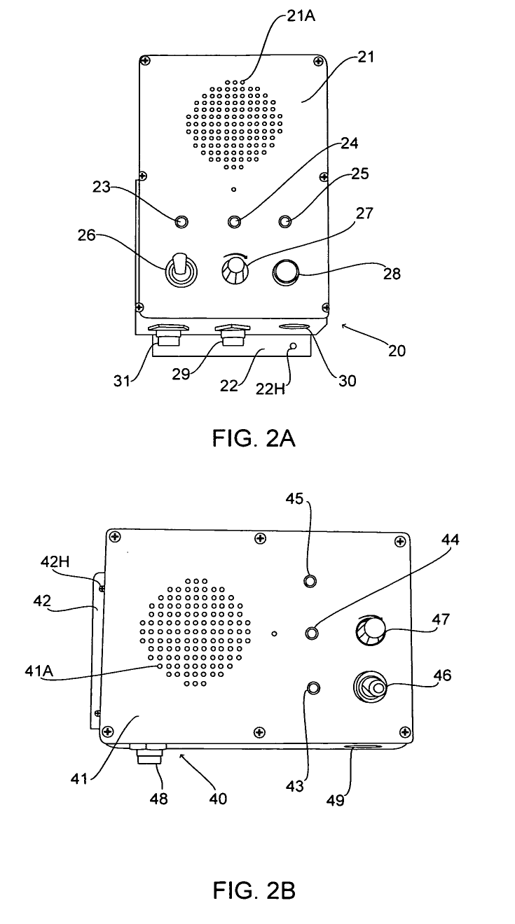

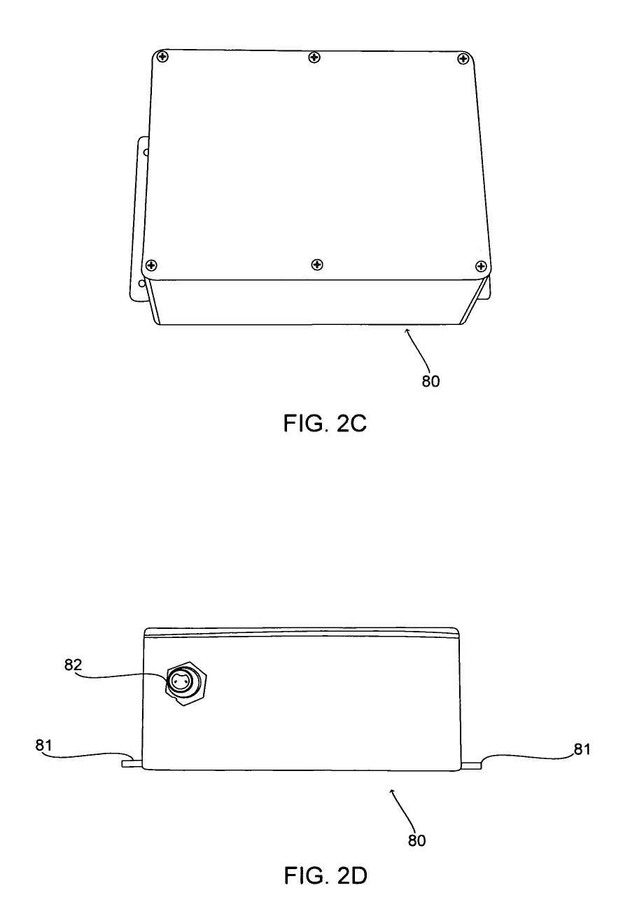

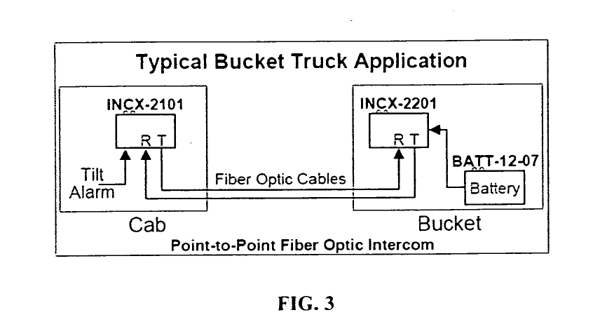

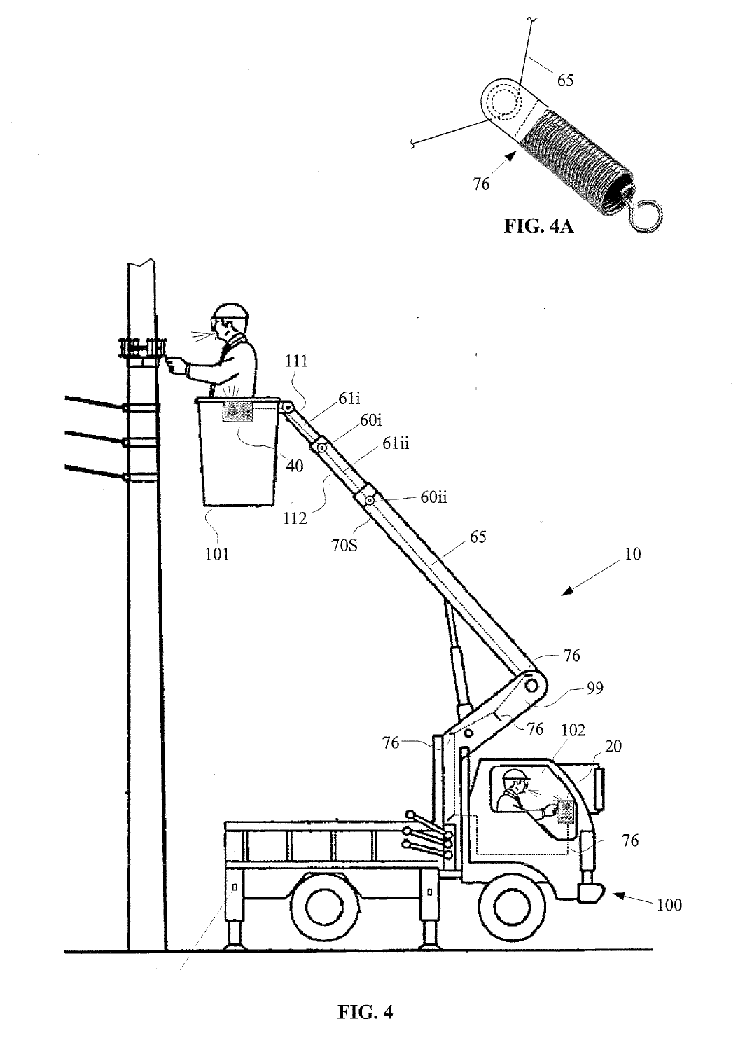

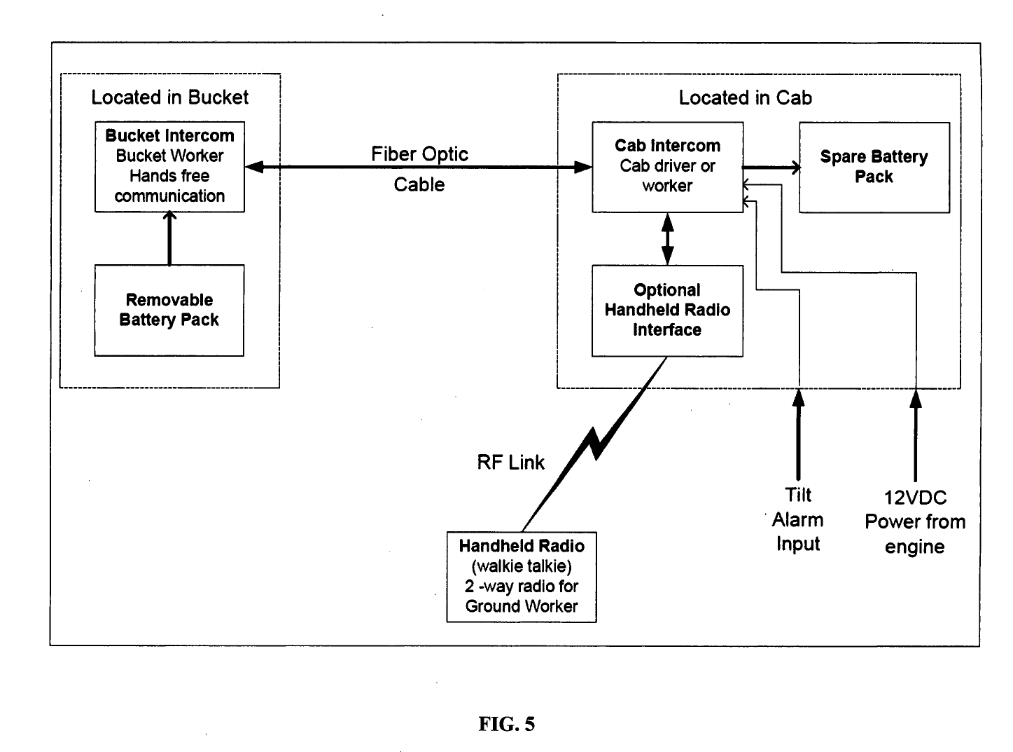

FIGS. 2A and 2B illustrate, respectively, a truck cab communication device 20 and a bucket communication device 40. The devices may be wired together conventionally; however, better isolation may be achieved with the communication devices 20 and 40 being coupled using fiber optic cable in accordance with the schematic of FIG. 3, which may nonetheless provide excellent sound quality for transmissions in either direction. This arrangement may be installed on a bucket truck 100 according to one embodiment of the invention, shown for the installation 10 of FIG. 4, to facilitate insulated bucket-to-cab communication during brief or extended bucket truck operations.

The truck cab communication device 20 may be a transceiver that may include an integrated speaker and a microphone. The transceiver may comprise a water-proof housing 21 that may be made of metal or plastic, and which may include one or more mounting flanges 22 with holes 22H therein, for mounting of the transceiver within the truck cab. The cab transceiver may preferably be powered from the truck. The housing 21 may have a plurality of openings 21A in a front facing side, to permits sound transmission to and from the transceiver interior, at which may be positioned the speaker and microphone. The electronic circuitry of the truck cab transceiver 20 may facilitate one or more indicator lights, which may include a power status light 23, labeled as “Power Ok,” a fiber optic link status 24, labeled as “Link Ok,” and a “Battery Status” light 25. An on/off switch 26 may selectively admit power to the unit, and a rotatable knob 27, which may be coupled to a potentiometer, can be used for volume adjustments. The transceiver 20 circuitry may also be wired to include a push-to-talk or push-to-transmit (PTT) button 28, the significance of which is discussed hereinafter. Several connector ports may be positioned on one side of the transceiver housing 21, for example on the bottom side, so that the receiver may be able to receive appropriate connectors, such as the industry standard ST and PC fiber optic cable connectors (see e.g., http://luxlink.com/faq/fiber_connectors.htm, the disclosures of which are incorporated herein by reference). A male port 29 and a female port 30 may accommodate a receive (“R”) fiber optic connector and a transmit (“T”) connector, respectively. A male port 31 may accommodate a connector from a cable for a tilt alarm.

The bucket communication device 40 may also be a transceiver that may be similarly constructed to include a water-proof housing 41 with a plurality of openings 41A being open to an integrated speaker and a microphone, and having one or more mounting flanges 42 with holes 4211 therein, for mounting of the transceiver to a portion of the bucket. To preserve electrical insulation of the bucket, the bucket transceiver 40 may include and be powered by an accessible, rechargeable battery pack, which may preferably be waterproof. In an alternate embodiment shown in FIG. 2C, a battery pack 80 may be located within a separate water proof housing. A quick release clamp or clamps, which are known in the art (see e.g., http://www.grizzly.com/products/Kreg-Bench-Klamp-System/T21175), may be used to mount the flanges 81 of the battery unit to the bucket, with a waterproof connector being used to electrically couple the port 82 (FIG. 2D) of the battery 80 to the transceiver 40. The battery unit and clamp(s) may be removed at night or upon completion of the maintenance tasks, to be recharged in the cab, as discussed hereinafter. The electronic circuitry of the bucket transceiver 40 may also facilitate one or more indicator lights, which may include a power status light 43, labeled as “Power Ok,” a fiber optic link status 24, labeled as “Link Ok,” and a “Recharge Status” light 45 that may warn of the need to recharge the bucket transceiver battery. An on/off switch 46 may selectively admit power to the unit, and a rotatable knob 47, which may be coupled to a potentiometer, can be used for volume adjustments.

Unlike the cab transceiver 20, the bucket transceiver 40 is preferably is not a PTT device, and may instead comprise a hands-free voice transmission system to relieve the work-load of the bucket worker, and allow communications therefrom even when the worker may be in the middle of performing a critical operation on live electrical wiring. The hands-free transmission system may be accommodated by transmitting continuously, once the worker is situated in the bucket and ready to be elevated, and has powered on the transceiver unit 40. Alternatively, the hands-free transmission system may be accommodated by utilizing a voice-activated microphone, which may, for example, comprise the voice-activated switch disclosed by expired U.S. Pat. No. 5,430,826 to Webster, the disclosures of which are incorporated herein by reference. A pair of connector ports may be positioned on one side of the bucket transceiver housing 41, for example the bottom side, so that the receiver may be able to receive appropriate connectors. A male port 48 and a female port 49 may accommodate a receiver (“R”) and a transmit (“T”) fiber optic connector, respectively.

Each of the transceivers 20 and 40 may comprise an encoder to convert the respective microphone's electrical signal into a modulated optical signal for transmission through the fiber optic cable. Each transceiver may also comprise a decoder to convert the received modulated optical signal into an electrical signal for use by the respective speaker in creating the voice transmissions. As seen in FIG. 3, a fiber optic cable having a connector coupled to the male “receive” port 29 of the cab transceiver 20 may have the connector on the other end coupled to the female “transmit” port 49 of the bucket transceiver 40. Also, a fiber optic cable having a connector coupled to the female “transmit” port 30 of the cab transceiver 20 may have the connector on the other end coupled to the male “receive” port 48 of the bucket transceiver 40.

A bucket truck 100 is shown in FIG. 4, with the bucket 101 elevated at some height above the ground, with a bucket worker positioned therein and performing electrical maintenance tasks on a utility pole, while a second worker is positioned inside the cab 102 of the bucket truck. One embodiment of the intercom system 10 of the present invention is shown installed thereon. The transceiver 40 may be secured to a portion of the bucket 101 by receiving mechanical fasteners through the holes 4211 of the flange 42 of the transceiver housing 41. The transceiver 40 may be positioned anywhere on the bucket that may be convenient, both in terms of convenience to the bucket worker, by not obstructing the workers movements therein, as well as being relatively close, so as to readily receive words that are spoken by the bucket worker in a normal voice. Although the transceiver may be received within a control panel of the bucket 101 for the manufacture of new trucks incorporating the disclosures of this invention therein, a position on the side of the bucket, as shown, may be convenient for retrofit installation of the transceiver 40. The cab transceiver 20 may conveniently be mounted within cab 102 of truck 100 using mechanical fasteners received through the holes 2211 of the flange 22 of the transceiver housing 21. The transceiver 20 may be wired directly to the truck's battery to receive 12 VDC power therefrom, or it may be wired to any 12V source in the cab wiring harness.

The use of fiber optic cable between the two receivers 20 and 40, which may be tactical cable, serves to maintain high voltage electrical insulation between the bucket 101 and truck cab 102, while permitting bucket-to-cab communication that are free from electrical interference when the bucket is in proximity to power lines. The high voltage electrical isolation may comprise at least 10 KV/foot of isolation.

For some bucket trucks that have fixed (i.e., non-telescoping) booms that may simply rotate 360 degrees, the fiber optic cable may be attached to the arm with slack at the base, to accommodate limited rotation. However, in order to support the movements of articulating boom joints and/or telescoping boom sections, the fiber optic cable may not simply run directly from one transceiver to the other. The boom of the truck 100 in FIG. 4 has two sections, a first section 111 and section 112, that telescope out from the pivotable boom section 110. The bucket 100 is pivotally mounted to boom section 111. As the boom section 111 telescopes outward from boom section 112 to raise the height of the bucket above the ground to reach a destination worksite, the fiber optic cable must accommodate this extended distance between the transceivers, 20 and 40, which may range anywhere from 10 feet to 150 feet. Therefore the fiber optic cable must be selectively attached to the boom, rather than simply being strung across the boom sections. In a first embodiment, shown in FIG. 4, a self-storing fiber optic reel assembly positioned in proximity to a telescoping boom section accommodates extension of the section, to selectively interconnect the truck cab transceiver 20 with the bucket transceiver 40. Where multiple telescoping booms are present on a bucket truck, each telescoping section may be equipped with such a reel.

The self-storing fiber optic reel assembly 60 may, for example, be a modified version of the “Self-Storing Cord and Hose Reel Assemblies” of expired U.S. Pat. No. 4,384,688 to Smith, the disclosures of which are incorporated herein by reference. The reel assembly disclosed therein may have its housing modified to be usable on the boom sections of a bucket truck. Where the fiber optic cable is incorporated into the design of a new truck, a more elegant means of securing the reel and cable may be utilized, however, for retrofit onto the boom section of an existing bucket truck, the reel's housing may be secured by one of several mechanical means Simple sheet metal or extruded angle brackets may have one leg riveted to the reel housing and the other leg secured to the boom using bolts, with the bolt threads being received within shallow tapped holes in the booms outer diameter of the outer boom section. The tapped holes would need to be shallow so as not to penetrate to the point of locally weakening or interfering with the hydraulically driven cylinder. As an alternative to performing machining operations upon the boom sections, a flexible metal strap 70S may be riveted to the reel housing, and may also be secured to the boom section mechanically or using a suitable metal adhesive or by welding it thereto, or instead, a commonly available pipe clamp, possibly being a cushioned, split ring clamp 70C, may have the reel secured thereto, prior to being clamped to the diameter of the boom section. Examples of such clamps may be found online from the Grainer Industrial Supply Company, at: www.grainger.com/Grainger/pipe-hangers-and-clamps/pipe-and-tubing/plumbing/ecatalog/N-aa3.

As the self storing reel 60 disclosed by U.S. Pat. No. 4,384,688 to Smith utilizes one fixed plug/connector at a central position on the cylindrical reel housing, and another repositionable plug/connector on the end of the fiber optic cable that plays off the reel on demand, the arrangement for intercom system 10 may have a first reel 60i clamped on boom section 112 as shown in FIG. 4, and with the reel cable 61i therein being partially extended so as to have the connector(s) be received by the bucket transceiver ports. (Note that suitable connectors may be utilized on the end of the reel cable 61i to be compatible with the ports used on the transceivers, 20 and 40.)

A second reel 60ii may be positioned proximate to the end of boom section 110, and with the reel cable 61ii therein being partially extended so as to have the connector(s) on its end be received by the fixed port(s) in the central part of first reel 60i. A suitable length of fiber optic cable 65 may have its connector(s) at a first end be received within the fixed port(s) in the central part of second reel 60ii, while its connector(s) at a second end may be received within the ports in the cab transceiver 40. (Note that it may be preferable that the “gear-like teeth” of “arbor 63” as disclosed in the Smith reel not be utilized for the reels herein as they serve to tentatively inhibit retraction, so for intercom system 10, the reels 60i and 61ii would thus have automatic uptake of the fiber optic cable during boom retraction.)

To accommodate the rotational movements of the articulating boom joints and to also have the length of fiber optic cable 65 conform to the arms of the articulating boom even when static, a rope-to-swivel connector may be used to secure the fiber optic cable, such as the rope-to-swivel connector manufactured by General Machine Products Co. of Trevose, Pa. (with examples available online at http://www.gmptools.com/nf/71130.htm). As an alternative, the spring loaded pulley member 76 illustrated in FIG. 4A may be utilized to adjustably secure the fiber optic cable 65 to arm 99. This allows some play to be added to the length of the fiber optic cable 65 which may be necessary, depending upon the total angular movements experience by the arm. As seen for the arm 99 and boom section 110 of bucket truck 100 in FIG. 4, as the boom is rotated to raise the bucket 101 higher, the angle therebetween increases and incremental increases to the length of the cable may be necessary, especially when the angle between the boom and the arm becomes greater than 90 degrees, and when the pulley support 76 is not positioned proximate to the hinge point. The spring loaded pulley member 76 of FIG. 4A is merely illustrative, and may be manufactured in different ways, for example, by grinding the end of a helical tension spring flat and welding or mechanically fastening it to the body of the pulley member. Alternatively, the helical spring may have two looped ends, where one end may be bolted to the pulley member and the other looped end may be secured to the arm 99, using a standoff.

Several other enhancements may be made to the transceivers of intercom system 10 to improve its functionality and versatility. For example, as seen in the block diagram of FIG. 5, the cab transceiver 40 may contain an integral or an external battery charging unit. The charging unit may accommodate the rechargeable battery contained within the bucket transceiver 40, or preferably, a second battery may always be retained therein so as to be ready to immediately replace the one currently being used in the transceiver during repair operations. In addition, the cab transceiver 40 may contain an integral or an external radio interface that may permit communication with a handheld radio during bucket truck operations. The radio interface may preferably permit communication between either of or both of, the hands-free bucket transceiver and the cab transceiver, with a remote walkie-talkie or other transceiver, for distances of up to 10 miles, so a worker in the bucket or cab can coordinate with another utility worker performing related repairs down the block.

Lastly, the bucket truck intercom system 10 may further comprise a bucket tip sensor and an audible alarm in the bucket and/or in the cab, with the audible alarm indicating imminent tipping of the truck due to overreaching of the boom. The bucket tip sensor may comprise a load sensor positioned on each outrigger arm and a microprocessor that compares a reading from each of the outrigger arm load sensors to determine excessive imbalance due to the telescoping of the boom of the bucket truck.

The examples and descriptions provided merely illustrate a preferred embodiment of the present invention, Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

TABLE 1
TECHNICAL SPECIFICATIONS

| Audio Bandwidth (minimum) | 300 to 3500 Hz (+0, −3 dB) |
|---|---|
| Audio Input | Integral Microphone |
| Audio Output | 10 watts peak Speaker |
| Controls | Power, Push-to-Talk, |
| | Volume |
| Indicators | Battery State, Link, Power |
| Operating Wavelength | 850 nm |
| Optical Fiber | Rugged tactical cable |
| Electrical Isolation | 10 KV/inch (fiber cable alone) |
| Optical Output Power | −16 dBm (multimode) |
| Optical Loss Budget | 0-13 dB (multimode) |
| Optical Connectors | Industry standard ST |
| External Alarm Input | 11-16 VDC @ 100 mA |
| Operating Temperature | −35° to +75° C. |
| Power Requirements | 11-16 VDC @ 150 mA |
| Battery Life | 24 hours before recharging |
| Physical Size (mm) | 7.0″ (178) × 5.0″ (127) × |
| | 2.5″ (64) |

We claim:

1. Apparatus for use in improving the operational capability of a bucket truck comprising:
a truck cab transceiver, said truck cab transceiver comprising a speaker, and a voice-activated microphone;
a bucket transceiver, said bucket transceiver comprising a speaker and a voice-activated microphone;
a fiber optic cable configured to selectively interconnect said truck cab transceiver with said bucket transceiver; said fiber optic interconnection configured to maintain high voltage electrical isolation between the bucket and the truck cab, while permitting communication between said bucket transceiver and said truck cab transceiver to be free from electrical interference;
means for automatically taking-up and letting out a portion of said fiber optic cable between said bucket transceiver and said cab transceiver, as required by movement of said bucket transceiver; and
said truck cab transceiver comprising a radio interface configured to permit said interference free communication from said bucket transceiver to said cab transceiver, through said fiber optic cable, to be wirelessly communicated to a distal transceiver, to permit hands-free interference-free communication between said bucket transceiver and the distal transceiver.

2. A bucket truck intercom system, for use on an insulated bucket truck to facilitate cab-to-bucket and bucket-to-cab communication, and also bucket communication with a transceiver distal to the bucket truck, during bucket truck operations, while the bucket is in close proximity to high voltage power sources/lines, with the communication therefrom being free from electrical interference, said bucket truck intercom system comprising:
a truck cab transceiver, said truck cab transceiver comprising a speaker, and a voice-activated microphone;
a bucket transceiver, said bucket transceiver comprising a speaker and a voice-activated microphone;
a fiber optic cable configured to selectively interconnect said truck cab transceiver with said bucket transceiver; said fiber optic interconnection configured to maintain high voltage electrical isolation between the bucket and the truck cab, while permitting communication between said bucket transceiver and said truck cab transceiver to be free from electrical interference;
means for automatically taking-up and letting out a portion of said fiber optic cable between said bucket transceiver and said cab transceiver, as required by movement of said bucket transceiver; and
said truck cab transceiver comprising a radio interface configured to permit said interference free communication from said bucket transceiver to said cab transceiver, through said fiber optic cable, to be wirelessly communicated to a distal transceiver, to permit hands-free interference-free communication between said bucket transceiver and the distal transceiver.

3. The bucket truck intercom system according to claim 2 further comprising means for accommodating play in said fiber optic cable from articulating of the bucket truck arms.

4. The bucket truck intercom system according to claim 2 wherein said distal transceiver comprises a walkie-talkie.

5. The bucket truck intercom system according to claim 2 wherein said distal transceiver comprises a cab transceiver and radio interface of a second said bucket truck intercom system; and wherein said cab transceiver of said second bucket truck intercom system comprises a voice-activated microphone configured to permit communication between said cab transceiver of said second bucket truck intercom system and a bucket transceiver therein, through a fiber optic cable interconnected therebetween.

6. The bucket truck intercom system according to claim 2 wherein said bucket transceiver comprises an externally accessible rechargeable battery unit.

7. The bucket truck intercom system according to claim 6 wherein said cab transceiver further comprises a remote-battery charging unit configured to recharge said bucket-transceiver battery therein.

8. The bucket truck intercom system according to claim 6 wherein said bucket transceiver comprises a water-proof metal housing; and wherein said externally accessible rechargeable battery unit is waterproof.

9. The bucket truck intercom system according to claim 2 wherein said high voltage electrical isolation provided by said intercom system comprises at least 10 KV/foot of isolation.

10. The bucket truck intercom system according to claim 2 wherein said cab transceiver comprises an indicator light, said indicator light being from the group of indicator lights consisting of: a cab transceiver to bucket transceiver link status light; a battery charge condition light; and a power status light.

11. A bucket truck intercom system, for use on an insulated bucket truck to facilitate cab-to-bucket and bucket-to-cab communication during bucket truck operations, and also bucket communication with a transceiver distal to the bucket truck, with the bucket in close proximity to high voltage power sources/lines, said bucket truck intercom system comprising: a truck cab transceiver; a bucket transceiver; a length of fiber optic cable, a first end of said length of fiber optic cable coupled to said truck cab transceiver, and a second end of said length of fiber optic cable coupled to said bucket transceiver, to selectively interconnect said truck cab transceiver with said bucket transceiver; at least one spring biased self-storing fiber optic reel assembly configured to automatically let out and take up a portion of said length of said fiber optic cable between said first and second ends; and wherein said fiber optic interconnection is configured to maintain high voltage electrical isolation between said bucket transceiver and the truck cab transceiver while permitting cab-to-bucket and bucket-to-cab communication being free from electrical interference, said truck cab transceiver comprising a radio interface configured to permit said interference free communication from said bucket transceiver to said cab transceiver, through said fiber optic cable, to be wirelessly communicated to a transceiver distal from said bucket transceiver and cab transceiver.

12. The bucket truck intercom system according to claim 11 further comprising a spring-loaded pulley member configured to accommodate play in said fiber optic cable.

13. The bucket truck intercom system according to claim 11,
wherein said truck cab transceiver comprises an integrated speaker and microphone; and
wherein said bucket transceiver comprises an integrated speaker and microphone.

14. The bucket truck intercom system according to claim 13 wherein said microphone of said bucket transceiver comprises a hands-free microphone.

15. The bucket truck intercom system according to claim 13 wherein said truck cab transceiver comprises a push-to-talk transceiver.

16. The bucket truck intercom system according to claim 11 wherein said cab transceiver comprises an indicator light, said indicator light being from the group of indicator lights consisting of a cab transceiver to bucket transceiver link status light; a battery charge condition light; and a power status light.

17. The bucket truck intercom system according to claim 14 wherein said hands-free microphone of said bucket transceiver is configured to transmit continuously.

18. The bucket truck intercom system according to claim 14 wherein said hands-free microphone of said bucket transceiver is configured to be voice-activated.

19. The bucket truck intercom system according to claim 13 wherein said distal transceiver comprises a hand-held radio.

20. The bucket truck intercom system according to claim 13 wherein said microphone of said cab transceiver comprises a voice-activated microphone; and wherein said distal transceiver comprises a cab transceiver and radio interface of a second said bucket truck intercom system; and said cab transceiver of said second bucket truck intercom system comprises a voice-activated microphone configured to permit communication between said cab transceiver of said second bucket truck intercom system and a bucket transceiver therein, through a fiber optic cable interconnected therebetween.
